(19) United States
(12) Patent Application Publication
(10) Pub. No.: US 2010/0175568 A1
(43) Pub. Date: Jul. 15, 2010

(54) Method And Apparatus For Cutting Food Product

(75) Inventors: Cathryn Fritz-Jung, Grosse Pointe Farms, MI (US); Daniel Knipper, Berkley, MI (US); David Strother, Farmington Hills, MI (US)

Correspondence Address: HARNESS, DICKEY & PIERCE, P.L.C., P.O. BOX 828, BLOOMFIELD HILLS, MI, 48303, US

(73) Assignee: LITTLE CAESAR ENTERPRISES, INC., Detroit, MI (US)

(21) Appl. No.: 12/612,138

(22) Filed: Nov. 4, 2009

Related U.S. Application Data
(60) Provisional application No. 61/143,956, filed on Jan. 12, 2009.

(51) Int. Cl. A47J 43/04; B26D 1/00

(52) U.S. Cl. 99/537; 83/697

(57) ABSTRACT

A cutter apparatus for cutting a block of food product into smaller blocks. The cutter apparatus includes a support assembly and a plurality of cutting assemblies. The cutting assemblies are pivotally coupled to the support assembly. At least one of the cutting assemblies includes a handle and a cutting member being assembled to the handle. Each of the other cutting assemblies includes a handle and a plurality of cutting members being assembled to the handle.

### CROSS-REFERENCE TO RELATED APPLICATIONS

This application claims the benefit of U.S. Provisional Application No. 61/143,956, filed on Jan. 12, 2009. The entire disclosure of the above application is incorporated herein by reference.

### FIELD

The present disclosure relates to a cutter apparatus for cutting a block of food product into smaller blocks.

### BACKGROUND

This section provides background information related to the present disclosure which is not necessarily prior art.

A block of food product often needs to be cut into smaller pieces to be readily and practically useable. For example, a standard block of cheese can have a standard weight of 40 pound with standard dimensions of seven inches high, eleven inches across, and fourteen inches long. Such a block of cheese needs to be cut into smaller blocks to be shredded for use in the cooking of many dishes, such as pizza, in a restaurant.

The two methods commonly used to apply the shredded cheese to a pizza are the volumetric method, that is, measurement by volume, and the gravimetric method, that is, measurement by weight. The volumetric method is preferred to the gravimetric method because the former method does not need calibration and is faster to apply the shredded cheese to the pizzas than the latter method, thus in turn shortens the food delivery time. For the volumetric method to be most effectively employed, the consistency of the size of the shredded cheese is important. In order to obtain shredded cheese with consistent size, the size of the smaller blocks that are cut from the larger blocks needs to be consistent. Furthermore, the ability to provide higher cutting efficiency to provide more smaller blocks in a shorter time is important. Hence, automated cheese cutters, such as disclosed in U.S. Pat. Nos. 4,608,896, 6,549,823, and 4,646,602, employ multiple cutting wires to try to achieve good consistency and high efficiency. Automated Hydraulic and electrical machines are used to push the cutting wires through the cheese block. However, the high cost and large space requirements of automated machinery makes the aforementioned automated solutions less attractive.

### SUMMARY

This section provides a general summary of the disclosure, and is not a comprehensive disclosure of its full scope or all of its features.

In one form, the present disclosure provides a cutter apparatus for cutting a block of food product into smaller blocks. The cutter apparatus comprises a support assembly and a plurality of cutting assemblies. The cutting assemblies are pivotally coupled to the support assembly. At least one of the cutting assemblies comprises a handle and a cutting member being assembled to the handle. Each of the other cutting assemblies comprises a handle and a plurality of cutting members being assembled to the handle.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a cutter apparatus according to a first preferred embodiment having a block of cheese mounted thereon with cutting assemblies all raised in a non-used position and illustrating cutting steps;

FIG. 2 is a perspective view of the cutter apparatus shown in FIG. 1 with cutting assemblies all lowered into a cutting position;

FIG. 3 is a right side view of the cutter apparatus shown in FIG. 2;

FIG. 4 is a front side view of the cutter apparatus shown in FIG. 2;

FIG. 5 is a bottom view of the cutter apparatus shown in FIG. 2;

FIG. 6 is a back side view of the cutter apparatus shown in FIG. 2;

FIG. 7 is a top view of the cutter apparatus shown in FIG. 2;

FIG. 8 is a perspective view of the cutter apparatus shown in FIG. 1, having a smaller block of cheese mounted thereon with cutting assemblies all raised in a non-used position and illustrating other cutting steps;

FIG. 9 is a perspective view of a cutter apparatus according to a second preferred embodiment with cutting assemblies all lowered into a cutting position;

FIG. 10 is a right side view of the cutter apparatus shown in FIG. 9; and

FIG. 11 is a bottom view of the cutter apparatus shown in FIG. 9.

Corresponding reference numerals indicate corresponding parts throughout the several views of the drawings.

### DETAILED DESCRIPTION OF THE VARIOUS EMBODIMENTS

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When describing similar features of the various embodiments herein, like reference indicia may be used to describe the similar features. For example, similar features or components may be referred to in a second embodiment by adding 1000 to the reference indicia used in the first embodiment (e.g., a cutter apparatus 2 and a cutter apparatus 1002, a top working surface 46 and a top working surface 1046, etc.).

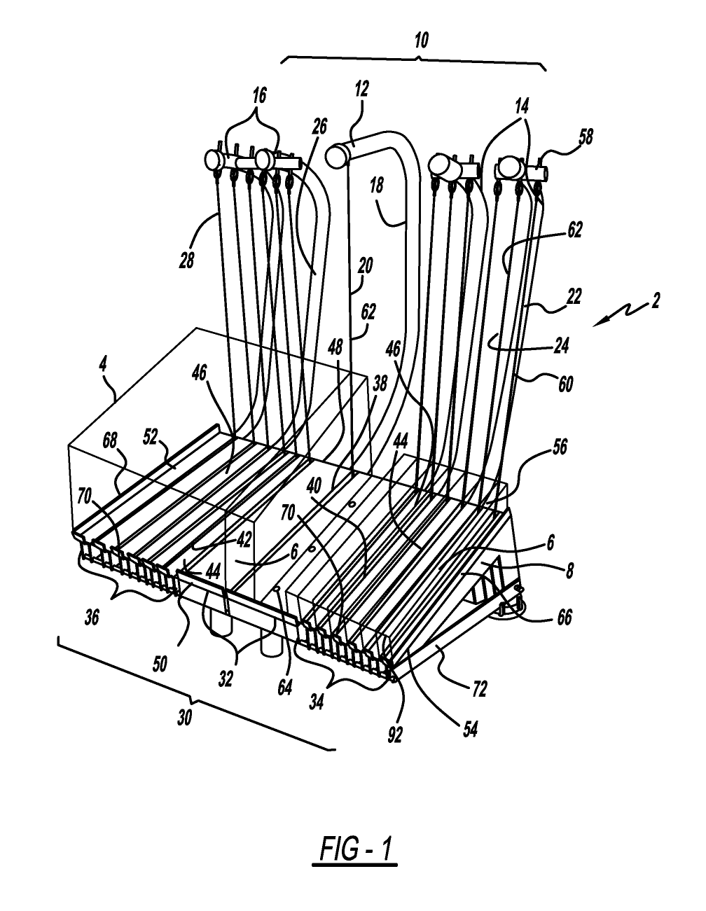

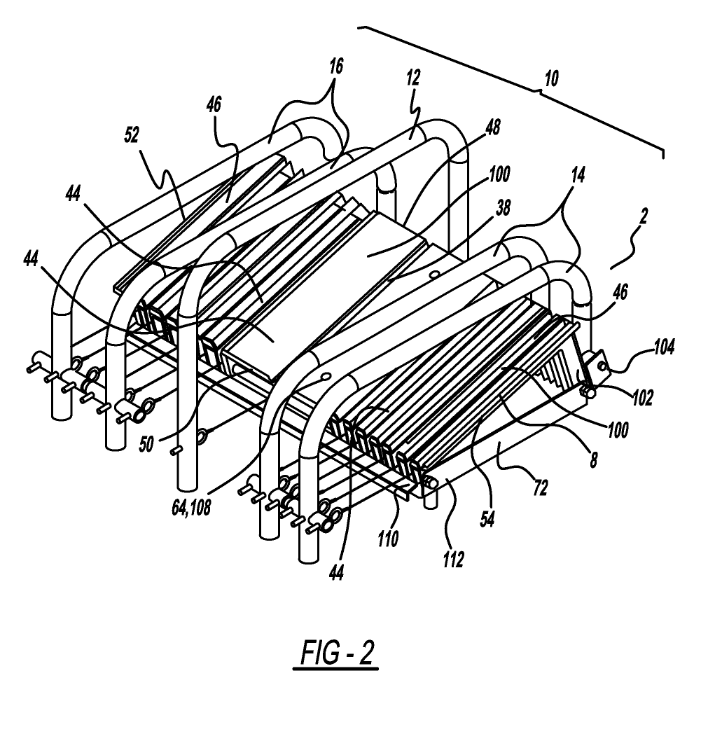

With reference to FIGS. 1 and 2, a cutter apparatus 2 according to a first preferred embodiment of the present disclosure for cutting a block of cheese 4 into smaller blocks 6 is shown. The cutter apparatus 2 can include a support assembly 8 and a plurality of cutting assemblies 10. The cutting assemblies 10 are pivotally coupled to the support assembly 8 and can include a middle cutting assembly 12, a plurality of right cutting assemblies 14, and a plurality of left cutting assemblies 16.

In the example provided, the cutting assemblies 10 include one middle cutting assembly 12, two right cutting assemblies 14, and two left cutting assemblies 16. The middle cutting assembly 12 has a middle handle 18 and a middle cutting member 20 being assembled to the middle handle 18. Each of the right cutting assemblies 14 has a right handle 22 and three right cutting members 24 being assembled to the right handle 22. Each of the left cutting assemblies 16 has a left handle 26 and three left cutting members 28 being assembled to the left handle 26.

The support assembly 8 can include a plurality of support members 30. The support members 30 can include a plurality of middle support members 32, a plurality of right support members 34, and a plurality of left support members 36. With reference to FIGS. 1, 2, and 6, in the example provided, each support member 30 of support assembly 8 has a main body 100 and a support arm 102. Each main body 100 of support member 30 has a generally planar and rectangular top surface 44. The left-to-right cross-section of the main body 100 of each support member 30 has a reversed U-shape. The top surfaces 44 of all the main bodies 100 define a generally planar and rectangular top working surface 46 of the support assembly 8. The top working surface 46 has a rearward side 48, a forward side 50, a left side 52, and a right side 54. The top working surface 46 can slope from a first location of higher elevation to a second location of lower elevation. The rearward side 48 of the top working surface 46 can be disposed at the first location of higher elevation and the forward side 50 of the top working surface 46 can be disposed at the second location of lower elevation. The slope allows the cutting members to engage the food product at a more advantageous cutting angle and can have an angle of 0° to 60° relative to horizontal.

The support members 30 can be coupled to and in spaced relation to each other such that they define a plurality of slots 38/40/42 for receiving the cutting members 20/24/28. In the example provided, the two middle support members 32 define one middle slot 38 for receiving the straight middle cutting member 20 of the middle cutting assembly 12. The six right support members 34 define six right slots 40 for receiving the six straight right cutting members 24 of the two right cutting assemblies 14. The six left support members 36 define six left slots 42 for receiving the six straight left cutting members 28 of the two left cutting assemblies 16.

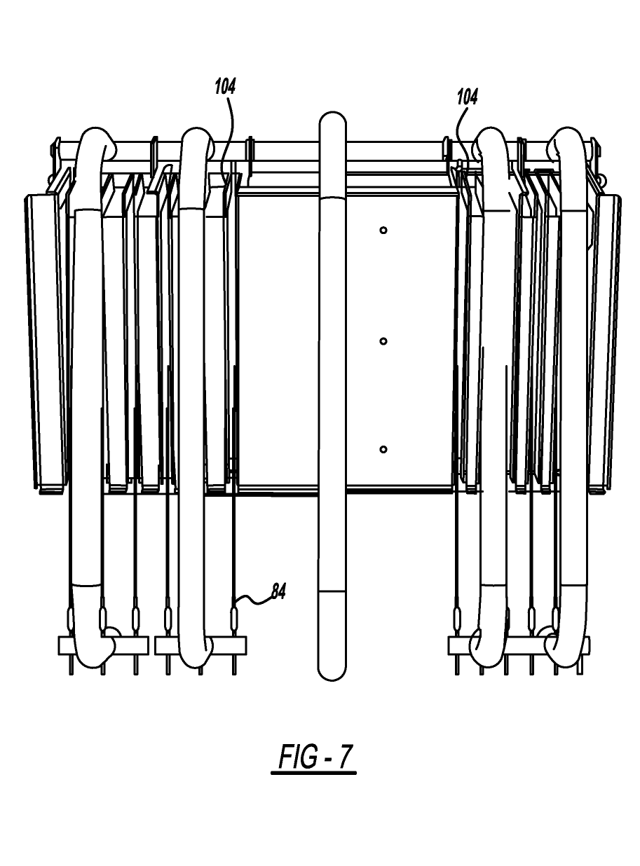

With reference to FIGS. 1, 2, 3, 6, and 7, the support assembly 8 has a rearward portion 104. The support arms 102 of all the support members 30 extend downward from the rearward side 48 of the top working surface 46 in the same direction and end at the rearward portion 104, such that the slots 38/40/42 defined by the support members 30 extend downward accordingly. The cutting assemblies 10 are pivotally coupled to the rearward portion 104. Each of the handles (18, 22, 22, 26, 26) of each cutting assembly 10 has a rearward end 56, a forward end 58, and a U-shaped bar 60. All the rearward ends 56 are pivotally coupled to the rearward portion 104 of the support assembly 8.

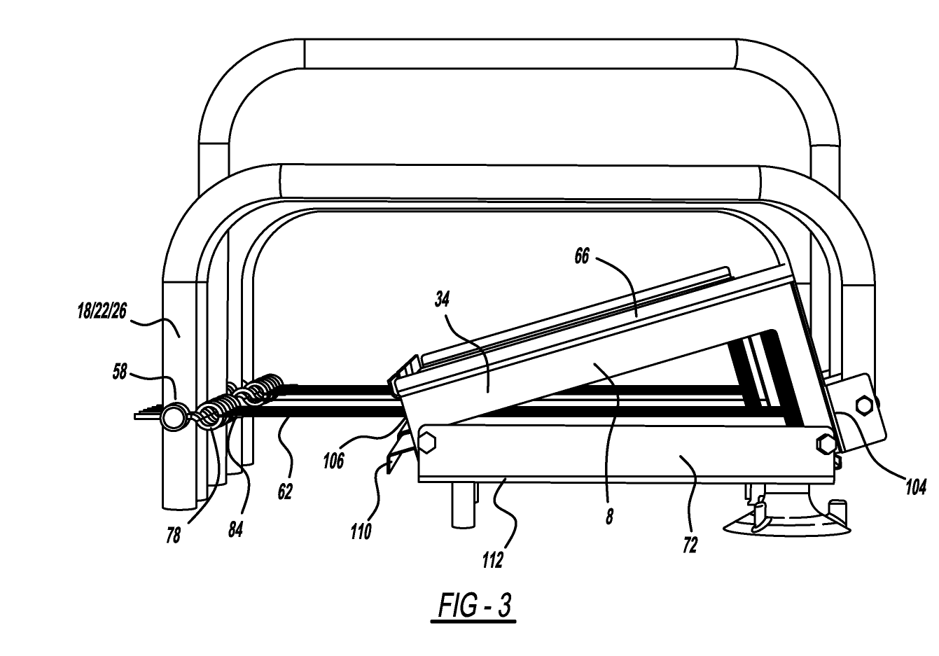

With specific reference to FIG. 3, the support assembly 8 can have a forward portion 106 and a first longest distance between the rearward portion 104 and the forward portion 106. Each handle (18, 22, 22, 26, 26) of each cutting assembly 10 can have a substantially same second distance between the respective rearward and forward ends. The second distance is bigger than the first longest distance for a predetermined value, such as three inches.

Each of the cutting members 20/24/28 can have a braided (or unbraided) wire 62 which can cut in a plane generally perpendicular to the top working surface 46 and parallel with the left side 52 of the top working surface 46. All the slots 38/40/42 can be parallel with the plane.

The wire 62 can be made of stainless steel and can have two ends. One end of the wire 62 can be assembled to the rearward end 56 of the respective handles 18/22/26 by any conventional fastening means well-known in the art, such as a hex nut, a cap nut, and a U-bolt, or a wing nut and an eye-bolt. With specific reference to FIG. 3, the other end of the wire 62 is assembled to the forward end 58 of the respective handles 18/22/26 by a fastening means, such as an eye-bolt 78, a hex nut (not shown), and a lock nut (not shown). The other end of the wire 62 goes through the eye of the eye-bolt 78 and is held together with the wire itself by a crimp sleeve 84.

With reference to FIGS. 2-5, the cutter apparatus 2 can include a middle guide 64, a right guide 66, a left guide 68, and a forward guide 70. In the example provided, the middle guide 64 has three projections 108 extending upward from the top surface 44 of the middle support member 32 on the right side. The three projections 108 are disposed from the middle slot 38 at a predetermined distance, such as for example two inches.

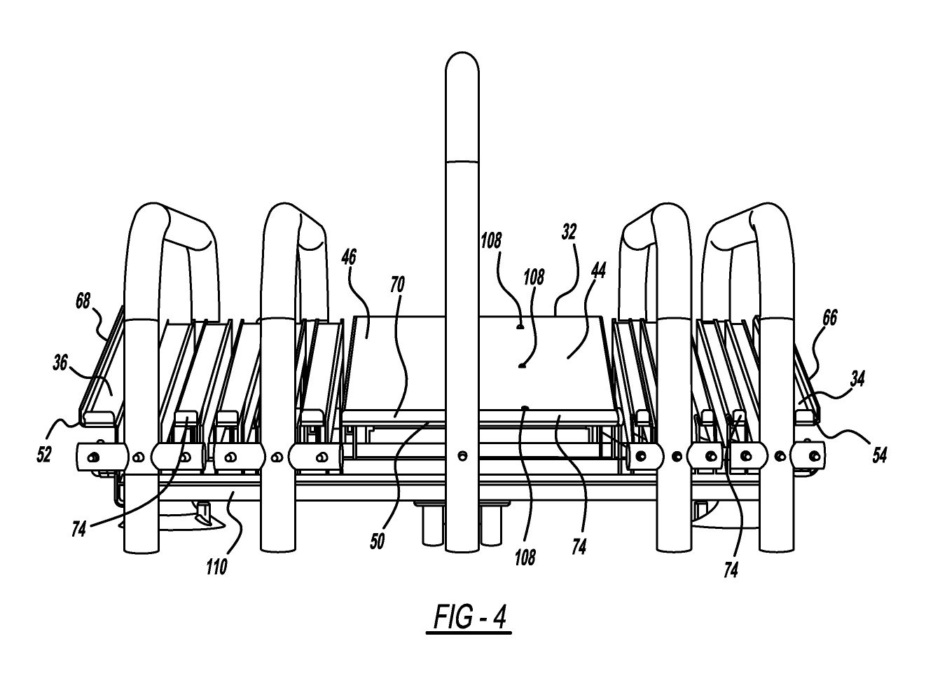

With specific reference to FIG. 4, the right guide 66 extends upward from the right side 54 of the top working surface 46. In the example provided, the right guide 66 extends upward from the right side of the rightmost right support member 34. The left guide 68 extends upward from the left side 52 of the top working surface 46. In the example provided, the left guide 68 extends upward from the left side of the leftmost left support member 36.

The forward guide 70 extends upward from the forward side 50 of the top working surface 46. Each middle support members 32, right support member 34, and left support member 36 has a tab 74 which extends upward from the forward side 50 of the top working surface 46. The forward guide 70 can include all the tabs 74 of all the middle support members 32, right support member 34, and left support member 36.

With reference to FIGS. 2-6, the cutter apparatus 2 can further include two food collecting members 110 disposed below the top working surface 46 of the support assembly 8. The support assembly 8 has a base 112. The two food collecting members 110 are slidably assembled to the base 112 and are configured to collect any cheese dropping from the cheese-cutting operation of the cutting apparatus 2. The food collecting members 110 can be a sheet metal or has other suitable forms and materials which are well-known in the art.

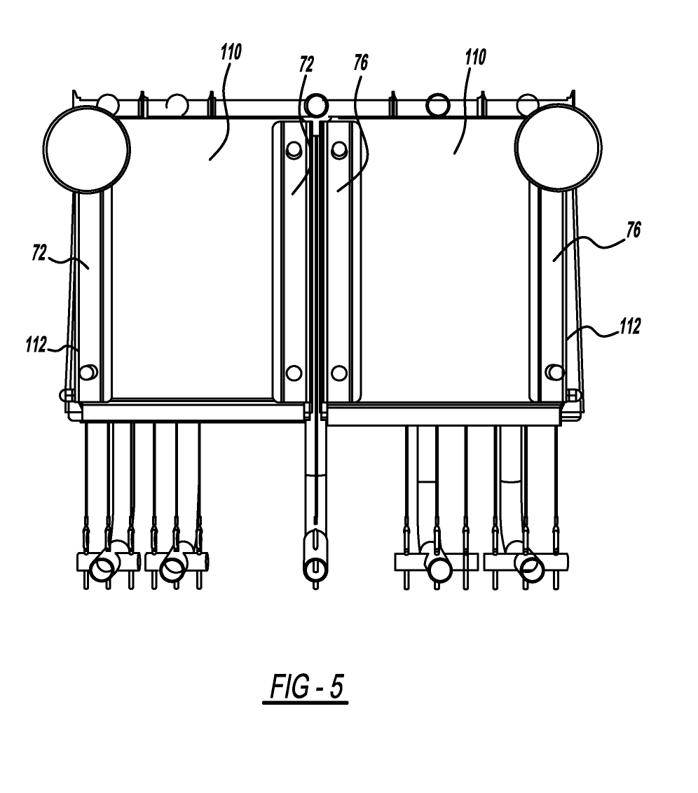

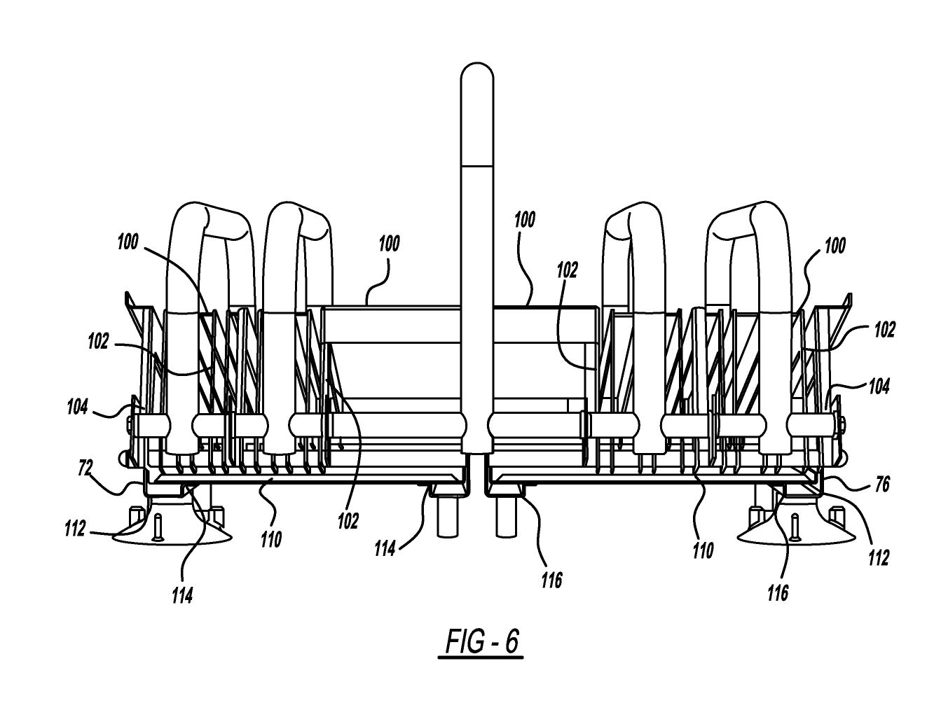

With specific reference to FIGS. 5-6, the base 112 can have a pair of L-shaped stainless steel plates 72 assembled to a right portion of the base 112 by a fastening means, such as nuts and bolts. The base 112 can have another pair of L-shaped stainless steel plates 76 assembled to a left portion of the base 112 by a fastening means, such as nuts and bolts.

The two pairs of L-shaped plates 72 and 76 form two pairs of guide tracks 114 and 116, respectively. The two pairs of guide tracks 114 and 116 extend in a forward and rearward direction and are configured to receive and guide the food collecting member 110 to be slid in the forward and rearward direction relative to the support assembly 8 between installed and uninstalled positions. A majority of the food collecting member 110 is disposed below the top working surface 46 when in the installed position.

When operating the cutter apparatus 2 as shown in FIG. 1, first, a human operator can place the block of cheese 4 onto the left portion of the top working surface 46 of the support assembly 8. By way of non-limiting example, the block of cheese 4 can have a standard weight of 40 pound with standard dimensions of seven inches high, eleven inches across, and fourteen inches long although other sizes and weights can be utilized. The operator can align the cheese 4 at the help of the guides. The operator can align the side with fourteen inches length with the forward guide 70, and aligns the side with eleven inches width with the middle guide 64. The middle guide 64 can stop the cheese at two inches between the middle guide 64 and the middle slot 38. Then the operator grasps and rotates the middle cutting assembly 12 to push the wire 62 in a plane generally perpendicular to the top working surface 46 through the entire block of cheese 4, resulting in a smaller block of cheese 6 with dimensions of two inches high, eleven inches across, and seven inches long.

Second, the operator can place the block of cheese 6 onto a right portion of the top working surface 46 of the support assembly 8. The operator aligns the cheese 6 at the help of the guides. The operator can align the side with seven inches length with the forward guide 70, and can align the side with eleven inches width with the right guide 66. Then the operator grasps and rotates one at a time the right cutting assembly 14 to push the wire 62 in a plane generally perpendicular to the top working surface 46 through the entire block of cheese 6, resulting in a plurality of smaller blocks of cheese 92, each of which, for example, can have dimensions of two inches high, eleven inches across, and one inches long.

Third, the operator can remove the blocks of cheese 92 and repeats the aforementioned first and second steps until the entire block of cheese 4 is cut into smaller blocks of cheese 92.

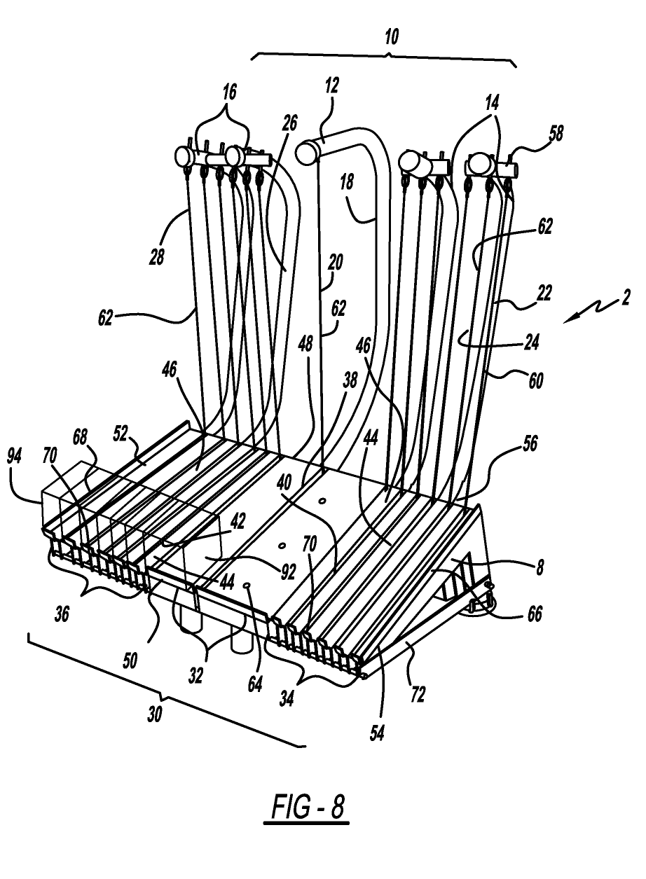

Optionally, as best seen in FIG. 8, the operator can place the blocks of cheese 92 onto a left portion of the top working surface 46 of the support assembly 8. The operator can align the cheese 92 at the help of the guides. The operator can align the side with eleven inches width with the forward guide 70, and aligns the side with either two inches height or one inch length with the left guide 68. Then the operator grasps and rotates one at a time the left cutting assembly 16 to push the wire 62 in a plane generally perpendicular to the top working surface 46 through the blocks of cheese 92, resulting in a plurality of smaller blocks of cheese 94, each of which, for example, can have dimensions of two inches long, one and five sixteenth inches across, and one inches high.

It can be appreciated that during the aforementioned second step the operator could stack a plurality of blocks of cheese 6 onto the right portion of the top working surface 46 of the support assembly 8. It can similarly be appreciated that during the aforementioned fourth step the operator could stack or place side by side a plurality of blocks of cheese 92 onto the left portion of the top working surface 46 of the support assembly 8. Moreover, there could be another step to slide the food collecting member 110 in a forward and rearward direction relative to the support assembly 8 between first and second positions to collect any cheese dropping from the aforementioned cheese-cutting operation of the cutting apparatus 2.

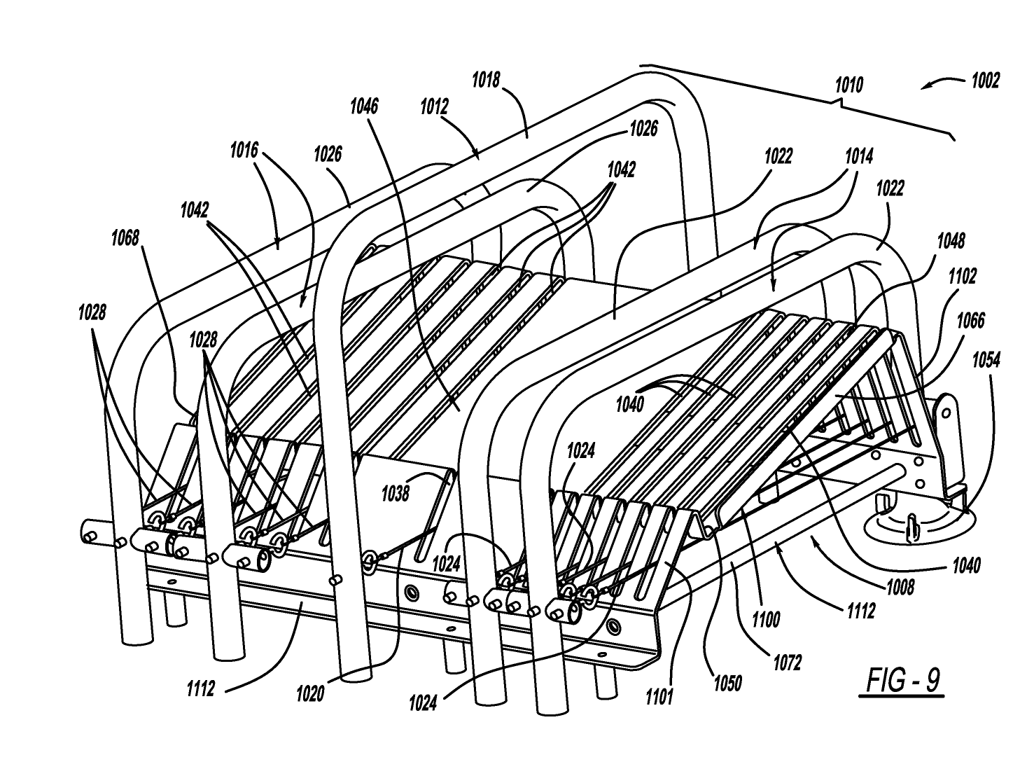

Referring now to FIGS. 9-11, a cutter apparatus 1002 according to a second preferred embodiment of the present disclosure is shown. Cutter apparatus 1002 is similar to cutter apparatus 2 of the first embodiment with the main differences in the design of support assembly and the base. As such, in the following description the components that are similar between cutter apparatus 1002 and cutter apparatus 2 may or may not be described.

The cutter apparatus 1002 can include a support assembly 1008 and a plurality of cutting assemblies 1010. The cutting assemblies 1010 are pivotally coupled to the support assembly 1008 and can include a middle cutting assembly 1012, a plurality of right cutting assemblies 1014, and a plurality of left cutting assemblies 1016.

In the example provided, the cutting assemblies 1010 include one middle cutting assembly 1012, two right cutting assemblies 1014, and two left cutting assemblies 1016. The middle cutting assembly 1012 has a middle handle 1018 and a middle cutting member 1020 being assembled to the middle handle 1018. Each of the right cutting assemblies 1014 has a right handle 1022 and three right cutting members 1024 being assembled to the right handle 1022. Each of the left cutting assemblies 1016 has a left handle 1026 and three left cutting members 1028 being assembled to the left handle 1026.

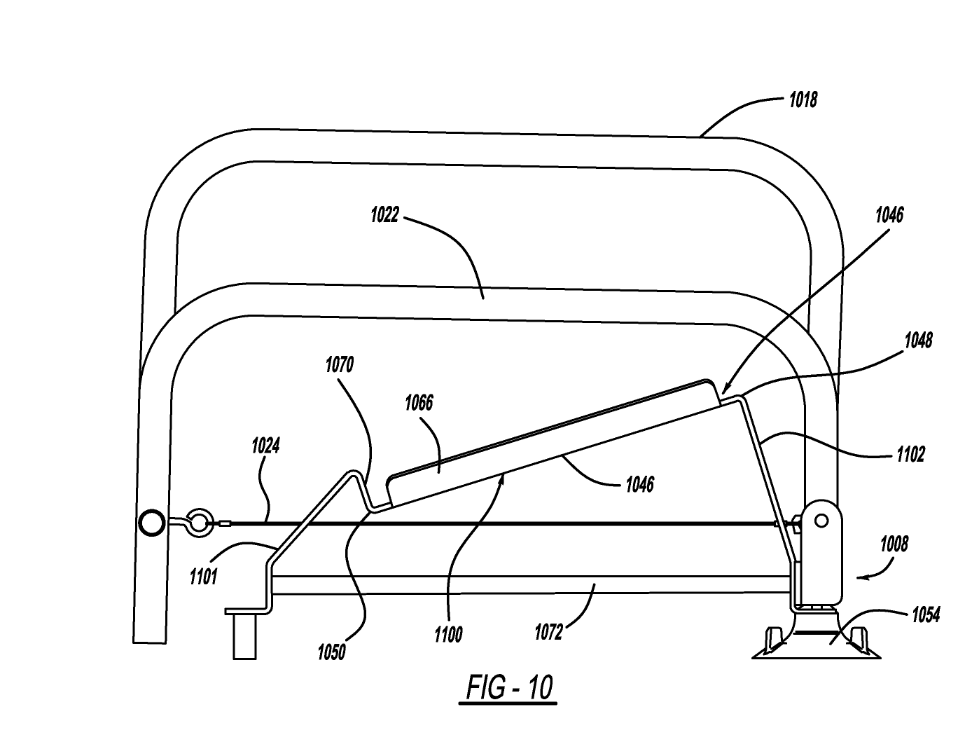

The support assembly 1008 can have a main body 1100, a forward support portion 1101, a rearward support portion 1102, a middle guide (not shown), a right guide 1066, a left guide 1068, and a forward guide 1070 (FIG. 10). The main body 1100 has a generally planar and rectangular top working surface 1046. The top working surface 1046 has a rearward side 1048, a forward side 1050, a left side 1052, and a right side 1054. The top working surface 1046 slopes from a first location of higher elevation to a second location of lower elevation. The rearward side 1048 of the top working surface 1046 is disposed at the first location of higher elevation and the forward side 1050 of the top working surface 1046 is disposed at the second location of lower elevation. The slope allows the cutting members to engage the food product at a more advantageous cutting angle and can have an angle of 0° to 60° relative to horizontal, and more preferably between 10° and 30°.

The rearward support portion 1102 extends downward from the rearward side 1048 of the top working surface 1046. The cutting assemblies 1010 are pivotally coupled to a lower end of the rearward support portion 1102. The forward guide 1070 extends upward from the forward side 1050 of the top working surface 1046. The forward support portion 1101 extends downward from an upper end of the forward guide 1070. A lower end of the forward support portion 1101 is lower than the forward side 1050 and is generally the same height with the lower end of the rearward support portion 1102.

The support assembly 1008 has a plurality of through slots 1038/1040/1042 for receiving the cutting members 1020/1024/1028. The slots 1038/1040/1042 extend continuously between the lower end of the forward support portion 1101 and the lower end of the rearward support portion 1102. In the example provided, the slots 1038/1040/1042 include one middle slot 1038 for receiving the straight middle cutting member 1020 of the middle cutting assembly 1012, six right slots 1040 for receiving the six straight right cutting members 1024 of the two right cutting assemblies 1014, and six left slots 1042 for receiving the six straight left cutting members 1028 of the two left cutting assemblies 1016. The main body 1100, the forward support portion 1101, the rearward support portion 1102, the middle guide (not shown), the right guide 1066, the left guide 1068, and the forward guide 1070 of the support assembly 1008 can be made from a stainless steel sheet metal with a one-eighth to one-fourth inch thickness or other materials which are well-known in the art with different thickness.

Each cutting member 1020/1024/1028 can have a braided (or unbraided) wire 1062 which can cut in a plane generally perpendicular to the top working surface 1046 and parallel with the left side 1052 of the top working surface 1046. All the through slots 1038/1040/1042 can be parallel with the plane.

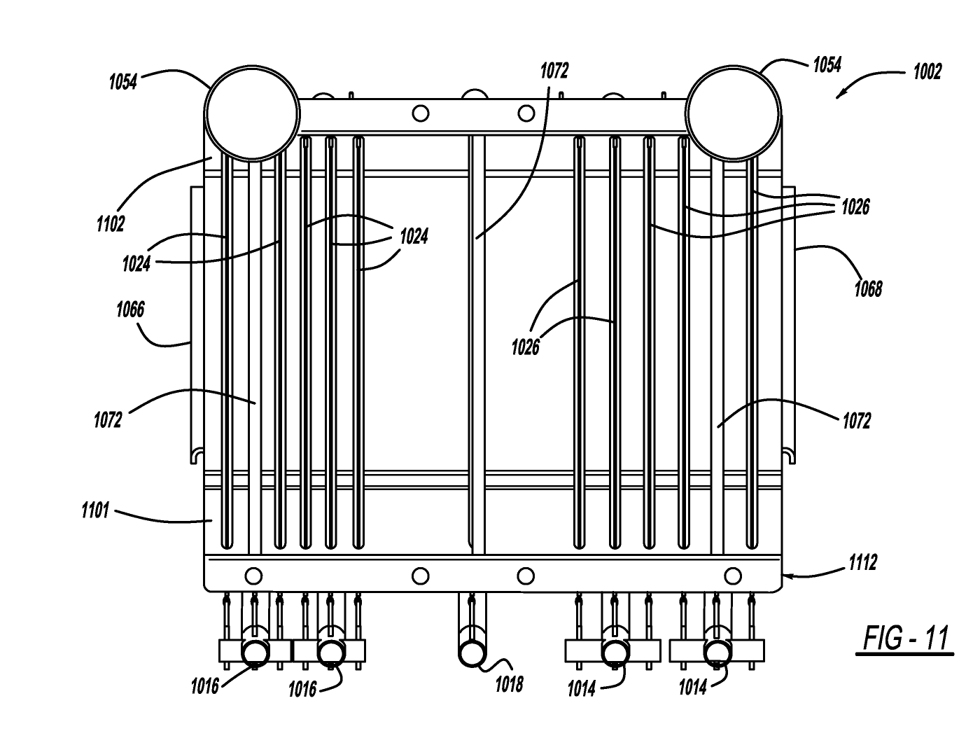

The support assembly 1008 can have a base 1112. With specific reference to FIG. 11, the base 1112 can have three stainless steel rods 1072 disposed in a forward and rearward direction in a right portion, a left portion, and a middle portion of the base 1112, respectively. Forward ends of the three rods 1072 can be coupled to the lower end of the forward support portion 1101 by a fastening means, such as nuts and bolts. Rearward ends of the three rods 1072 can be coupled to the lower end of the rearward support portion 1102 by a fastening means, such as nuts and bolts.

With specific reference to FIG. 10, the support assembly 1008 can have a first longest distance between the forward support portion 1101 and the rearward support portion 1102. Each handle 1018/1022/1026 of each cutting assembly 1010 can have a substantially same second distance between respective rearward and forward ends of each cutting assembly 1010. The second distance is longer than the first longest distance for a predetermined value, such as a few inches.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A cutter apparatus for cutting a block of food product into smaller blocks comprising:
a support assembly; and
a plurality of cutting assemblies pivotally coupled to the support assembly,
at least one of the cutting assemblies comprising a handle and a cutting member being assembled to the handle, each of the other cutting assemblies comprising a handle and a plurality of cutting members being assembled to the handle.

2. The cutter apparatus of claim 1, wherein the support assembly comprises a plurality of support members, the support members being coupled to and in spaced relation to each other such that the support members define a plurality of slots for receiving the cutting members.

3. The cutter apparatus of claim 2, wherein each support member of the support assembly has a generally planar and rectangular top surface, the top surfaces of all the support members defining a generally planar and rectangular top working surface of the support assembly, the top working surface having a forward side, a rearward side, a left side, and a right side.

4. The cutter apparatus of claim 3, wherein the top working surface slopes from a first location of higher elevation to a second location of lower elevation.

5. The cutter apparatus of claim 4, wherein the rearward side of the top working surface is disposed at the first location of higher elevation and wherein the forward side of the top working surface is disposed at the second location of lower elevation.

6. The cutter apparatus of claim 1, wherein the support assembly has a rearward portion and wherein the cutting assemblies are pivotally coupled to the rearward portion of the support assembly.

7. The cutter apparatus of claim 6, wherein each handle of each cutting assembly comprises a forward end and a rearward end, the rearward end being pivotally coupled to the rearward portion of the support assembly.

8. The cutter apparatus of claim 1, wherein the support assembly comprises a plurality of slots for receiving the cutting members.

9. The cutter apparatus of claim 8, wherein the support assembly is formed from a unitary plate having a generally planar top working surface and a rearward support portion angled relative to said generally planar top working surface.

10. The cutter apparatus of claim 9, wherein said working surface is sloped in a downward direction extending from said rearward support portion.

11. The cutter apparatus of claim 1, wherein each handle comprises a U-shaped bar.

12. The cutter apparatus of claim 1, wherein said plurality of cutting assemblies comprise a middle cutting assembly, a plurality of right cutting assemblies, and a plurality of left cutting assemblies, the middle cutting assembly comprising a middle handle and a middle cutting member being assembled to the middle handle, each of the right cutting assemblies comprising a right handle and a plurality of right cutting members being assembled to the right handle, each of the left cutting assemblies comprising a left handle and a plurality of left cutting members being assembled to the left handle.

13. The cutter apparatus of claim 12, wherein each of the right cutting assemblies comprise at least two right cutting members, each of the left cutting assemblies comprise at least two left cutting members.

14. The cutter apparatus of claim 13, wherein each cutting member comprises a braided wire, the braided wire having two ends, one end of the braided wire being assembled to the forward end of the handle, the other end of the braided wire being assembled to the rearward end of the handle.

15. A cutter apparatus for cutting a block of food product into smaller blocks comprising:
a support assembly comprising a plurality of slots for receiving the cutting members, wherein the support assembly is formed from a unitary plate having a generally planar top working surface and a rearward support portion angled relative to said generally planar top working surface; and
a plurality of cutting assemblies pivotally coupled to the support assembly, each of said cutting assemblies comprising a handle and at least one cutting member being assembled to the handle.

16. The cutter apparatus of claim 15, wherein the top working surface slopes from a first location of higher elevation to a second location of lower elevation.

17. The cutter apparatus of claim 16, wherein the rearward side of the top working surface is disposed at the first location of higher elevation and wherein the forward side of the top working surface is disposed at the second location of lower elevation.

18. The cutter apparatus of claim 15, wherein the support assembly has a rearward portion and wherein the cutting assemblies are pivotally coupled to the rearward portion of the support assembly.

19. The cutter apparatus of claim 15, wherein each handle comprises a U-shaped bar.

20. The cutter apparatus of claim 15, wherein said plurality of cutting assemblies comprise a middle cutting assembly, a plurality of right cutting assemblies, and a plurality of left cutting assemblies, the middle cutting assembly comprising a middle handle and a middle cutting member being assembled to the middle handle, each of the right cutting assemblies comprising a right handle and a plurality of right cutting members being assembled to the right handle, each of the left cutting assemblies comprising a left handle and a plurality of left cutting members being assembled to the left handle.

21. The cutter apparatus of claim 20, wherein each of the right cutting assemblies comprise three right cutting members, each of the left cutting assemblies comprise three left cutting members.

22. The cutter apparatus of claim 20, wherein at least one of said plurality of cutting assemblies include a plurality of cutting members assembled to the handle.
